(19) United States
(12) Patent Application Publication
(10) Pub. No.: US 2015/0296918 A1
(43) Pub. Date: Oct. 22, 2015

(54) LIGHT-EMITTING MODULE AND SHOE EMBEDDING THE SAME

(71) Applicant: SHEN-KO TSENG, TAIPEI CITY (TW)

(72) Inventor: SHEN-KO TSENG, TAIPEI CITY (TW)

(21) Appl. No.: 14/691,578

(22) Filed: Apr. 21, 2015

(30) Foreign Application Priority Data
Apr. 22, 2014 (CN) 201420197595.X

(51) Int. Cl. A43B 3/00; F21V 23/04; F21V 23/00; H05B 33/08; F21V 33/00

(52) U.S. Cl. CPC A43B 3/001; H05B 33/0854; F21V 33/0008; F21V 23/005; F21V 23/0407; F21Y 2101/02

(57) ABSTRACT

The present invention discloses a light-emitting module. The light-emitting module comprises a light-emitting unit set and a control module. The control module comprises at least a first flashing mode, a second flashing mode, and a third flashing mode, wherein, the first flashing mode, the second flashing mode, and the third flashing mode are arranged by a pre-determined order. When the control module senses an external force, the control module sequentially switch between the first flashing mode, the second flashing mode, and the third flashing mode to control the light-emitting component group for a corresponding flashing.

### BACKGROUND OF THE INVENTION

1. Field of the Invention

The present invention relates to a light-emitting module, more particularly, to a light-emitting module with a control module for sensing an external force to sequentially switch between a first flashing mode, a second flashing mode, and a third flashing mode to control a light-emitting component group for a corresponding flashing.

2. Description of the Prior Art

Light-emitting diodes (LED) have been widely used in various lighting devices and gradually become the mainstream of market. As light-emitting diodes have benefits such as small size, long life and resistance to impact, etc., light-emitting diodes are paid attention by many domestic and international manufacturers.

In order to increase the dynamism and beauty, the conventional technology will set a variety of light in sports shoes or casual shoes, wherein it is the most common such shoes worn by the children. Especially in the night, it really gives a refreshing feeling for walking in the road and watching a flashing pedestrian feet with moving lights. However, a variety of light emitting requires electrical power. The light emitting devices are usually set in the shoes in conventional technology for enhancing the beauty of the shoes. In order to make more gorgeous glow, a trigger switch is usually used as a control switch in the product and can be triggered while a vibration switch is on.

Because traditional light-emitting devices or lighting devices typically contain a plurality of light emitting devices, such as light bulbs, light emitting diodes or cold-light emitting devices. Most of these light emitting devices will be coupled to the circuit boards and switches. Wherein, the switches are utilized to control these light-emitting units for flashing or the flashing of emitting light or the order of emitting light, which make the light-emitting devices or the lighting devices with different functions. For example, light emitting devices or lighting devices can generate changeable light with different situations at night or be utilized for identity and security purposes through these light-emitting units.

However, the plurality of light emitting units of the light emitting devices although can be installed in any order or a single pre-set pattern, but the light-emitting units just can be controlled to open or close in a single default order, which often appears to be quite monotonous and unable to attract the attention of users and other people around.

### SUMMARY OF THE INVENTION

Thus, the present invention provides a light-emitting module. The light-emitting module is able to utilize a controller for sensing an external force to control a plurality of light-emitting components sequentially switched for flashing between a first flashing mode, a second flashing mode, and a third flashing mode according to a flashing cycle.

The light-emitting module of the present invention comprises a light-emitting component group and a control module. The control module is coupled to the light-emitting component group. N flashing modes stored in the control module are arranged to form a flashing cycle according to a predetermined sequence, wherein when an external force is applied to the control module, the control module is switched to the next flashing mode according to the predetermined sequence and controls the light-emitting component group to emit light according to the next flashing mode; and when an (N+1)^{th} external force is applied to the control module, the control module is switched to a first flashing mode of the flashing cycle and controls the light-emitting component group to emit light according to the first flashing mode.

In a preferred embodiment, the N flashing modes comprise the first flashing mode, a second flashing mode, and a third flashing mode corresponding to a shaking flashing mode, a sequential flashing mode, and a round flashing mode respectively. The shaking flashing mode comprises at least one shaking procedure. The shaking procedure is that the light-emitting component group respectively flashes a plurality of times according to a predetermined direction. The sequential flashing mode comprises at least one sequential procedure. The sequential procedure is that the light-emitting component group respectively flashes one time according to the predetermined direction. The round flashing mode comprises at least one round procedure. The round procedure is that the light-emitting component group respectively flashes one time according to the predetermined direction, and respectively and reversely flashes one time according to the predetermined direction.

In another preferred embodiment, the N flashing modes comprise the first flashing mode, a second flashing mode, and a third flashing mode corresponding to a shaking flashing mode, a sequential flashing mode, and a full flashing mode respectively. The shaking flashing mode comprises at least one shaking procedure. The shaking procedure is that the light-emitting component group respectively flashes a plurality of times according to a predetermined direction. The sequential flashing mode comprises at least one sequential procedure. The sequential procedure is that the light-emitting component group respectively flashes one time according to the predetermined direction. The full flashing mode comprises at least one full procedure. The full procedure is that the light-emitting component group flashes simultaneously.

Moreover, in another specific embodiment, the N flashing modes comprise the first flashing mode, a second flashing mode, and a third flashing mode corresponding to a sequential flashing mode, a scrolling flashing mode, and a full flashing mode respectively. The sequential flashing mode comprises at least one sequential procedure. The sequential procedure is that the light-emitting component group respectively flashes one time according to the predetermined direction. The scrolling flashing mode comprises at least one scrolling procedure. The scrolling procedure is that the light-emitting component group flashes in a round non-unidirectional way according to the predetermined direction. The full flashing mode comprises at least one full procedure. The full procedure is that the light-emitting component group flashes simultaneously.

Moreover, in another preferred embodiment, the N flashing modes comprise the first flashing mode and a second flashing mode corresponding to a sequential flashing mode and a meteor flashing mode respectively. The sequential flashing mode comprises at least one sequential procedure. The sequential procedure is that the light-emitting component group respectively flashes one time according to the predetermined direction. The meteor flashing mode comprises at least one meteor procedure. The meteor procedure is that the light-emitting component group respectively flashes and sequentially adjusts the brightness of the light-emitting component group according to the predetermined direction.

Finally, the control module comprises a circuit board, a control chip, a power supply module, and a vibration sensing component. The circuit board has a first surface, a corresponding second surface, and a side surface. The control chip is coupled and mounted to the first surface of the circuit board for being coupled to and controlling the light-emitting component group. The power supply module is coupled and mounted to the second surface of the circuit board. The vibration sensing component is coupled to the second surface of the circuit board and mounted to the side surface of the circuit board. Wherein, the circuit board has a tongue portion, the tongue portion is extended outwards from the side surface of the circuit board for being coupled to the vibration sensing component.

The present invention further provides a light-emitting module comprising a light-emitting component group and a control module. The control module is coupled to the light-emitting component group. N flashing modes stored in the control module for controlling the light-emitting component group to light. The N flashing modes arranged from a first flashing mode to an N^{th} flashing mode to form a flashing cycle, and N is an integer number larger than 3. Wherein, when an X^{th} external force is applied to the control module, the control module is switched from an (x−1)^{th} flashing mode to an X^{th} flashing mode, and x is smaller than or equal to N.

In a preferred embodiment, when the X^{th} external force is applied and the (x−1)^{th} flashing mode is not finished yet, the control module terminates the (x−1)^{th} flashing mode and directly controls the light-emitting component group to flash according to the X^{th} flashing mode.

In another preferred embodiment, when the X^{th} external force is applied and the (x−1)^{th} flashing mode is not finished yet, the control module controls the light-emitting component group to flash sequentially according to the X^{th} flashing mode after the light-emitting component group is finished to flash according to the (x−1)^{th} flashing mode.

In another preferred embodiment, when the X^{th} external force is applied and the (x−1)^{th} flashing mode is not finished yet, the control module is switched to the X^{th} flashing mode after the light-emitting component group is finished to flash according to the (x−1)^{th} flashing mode, and when an (x+1)^{th} external force is applied, the control module controls the light-emitting component group to flash according to the X^{th} flashing mode.

The present invention further provides a light-emitting module comprising a light-emitting component group, a control module, and a selective switch. The control module is coupled to the light-emitting component group. N flashing modes is stored in the control module for controlling the light-emitting component group to emit light. A selective switch is coupled to the control module.

Wherein when the selective switch is triggered by a user, the control module selects x flashing modes from the N flashing modes, and the x flashing modes arranged from a first flashing mode to an X^{th} flashing mode to form a flashing cycle, N and x are a positive integer number respectively, and x is smaller than N.

Wherein when an y^{th} external force is applied to the control module, the control module is switched from an (y−1)′^{h} flashing mode to an y^{th} flashing mode for controlling the light-emitting component group to emit light, and y is smaller than or equal to x; and when an (x+1)^{th} external force is applied to the control module, the control module controls the light-emitting component group to emit light according the first flashing mode.

Compared to the prior arts, the present invention provides a light-emitting module. The light-emitting module is able to utilize a controller for sensing an external force to control a plurality of light-emitting components sequentially switched for flashing between the first flashing mode, the second flashing mode and the third flashing mode according to a flashing cycle, which enhances the light-emitting module to flash in various ways. At the same time, the control module of the light-emitting module of the present invention is simple. Therefore the light-emitting module is able to provide the light emitting or lighting function with saving space to solve the disadvantages in the prior arts.

The present invention has a novel structure that can be used for industries to achieve improvement and apply for new patents. In order for the purpose, characteristics and advantages of the present invention to be more clearly and easily understood, the embodiments and appended drawings thereof are discussed in the following.

### BRIEF DESCRIPTION OF THE APPENDED DRAWINGS

FIG. 1 is a schematic perspective view illustrating the light-emitting module of the present invention according to a preferred embodiment.

FIG. 2A is a schematic top view illustrating the light-emitting module of the present invention according to a preferred embodiment.

FIG. 2B is a schematic bottom view illustrating the light-emitting module of the present invention according to a preferred embodiment.

FIG. 2C is a schematic diagram of side surface illustrating the light-emitting module of the present invention according to a preferred embodiment.

FIG. 2D is a schematic diagram of the other side surface illustrating the light-emitting module of the present invention according to a preferred embodiment.

FIG. 3 is a simplified functional block diagram illustrating the light-emitting module of the present invention according to a preferred embodiment.

FIG. 4 is a schematic circuit diagram illustrating the light-emitting module of the present invention according to a preferred embodiment.

FIG. 5A to FIG. 5C are waveform diagrams of first flashing circuit, second flashing circuit, and third flashing circuit respectively illustrating the light-emitting component group in the light-emitting module of the present invention according to a preferred embodiment.

FIG. 6A to FIG. 6C are waveform diagrams of first flashing circuit, second flashing circuit, and third flashing circuit respectively illustrating the light-emitting component group in the light-emitting module of the present invention according to another preferred embodiment.

FIG. 7A to FIG. 7C are waveform diagrams of first flashing circuit, second flashing circuit, and third flashing circuit respectively illustrating the light-emitting component group in the light-emitting module of the present invention according to another preferred embodiment.

FIG. 8 is a waveform diagram of first flashing circuit illustrating the light-emitting component group in the light-emitting module of the present invention according to another preferred embodiment.

FIG. 9A to FIG. 9G are diagrams of second flashing circuit illustrating the light-emitting component group in the light-emitting module of the present invention according to another preferred embodiment.

FIG. 10 is a schematic diagram illustrating the light-emitting module of the present invention embedded in a shoe.

### DETAILED DESCRIPTION OF THE INVENTION

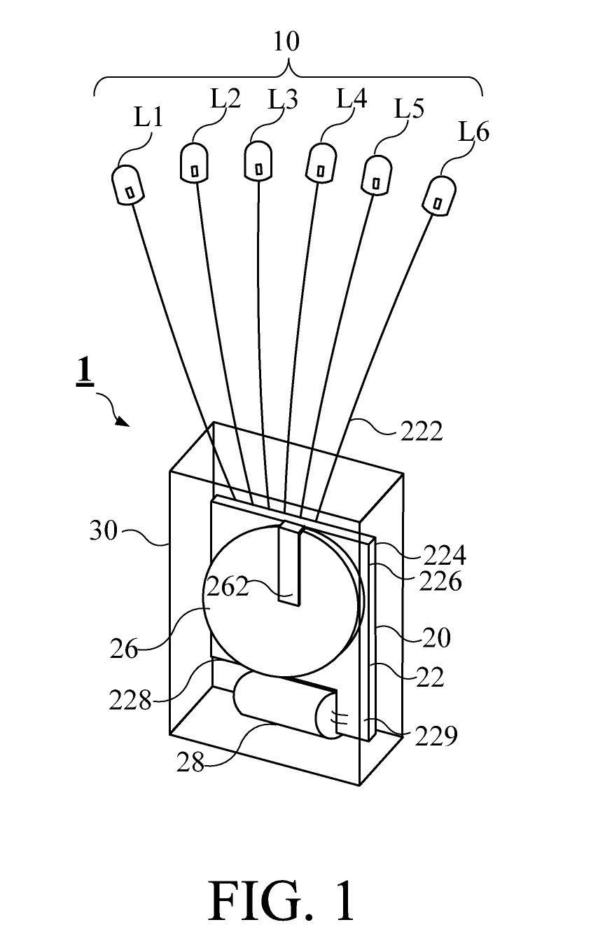

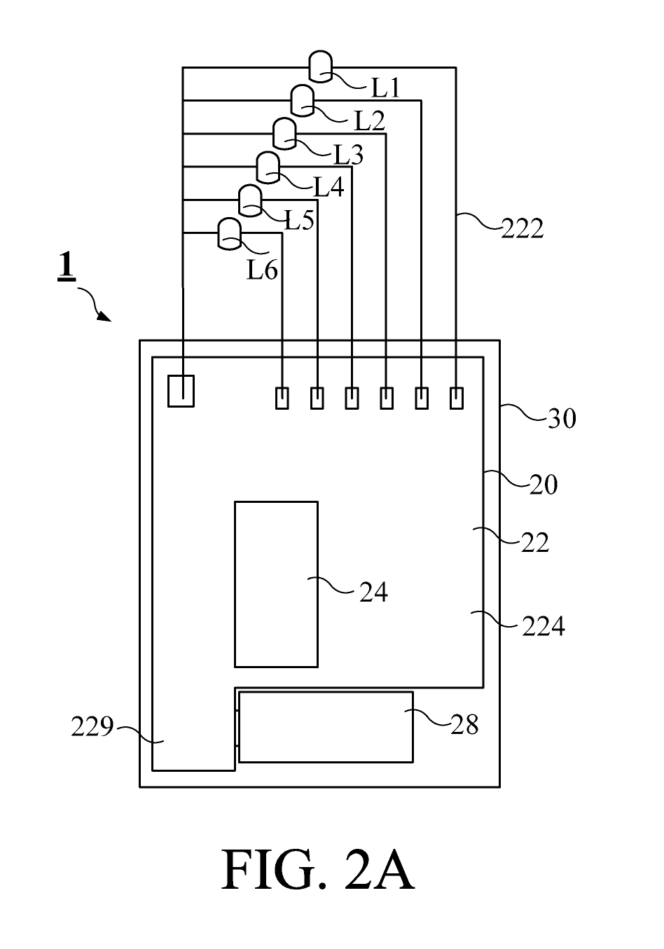

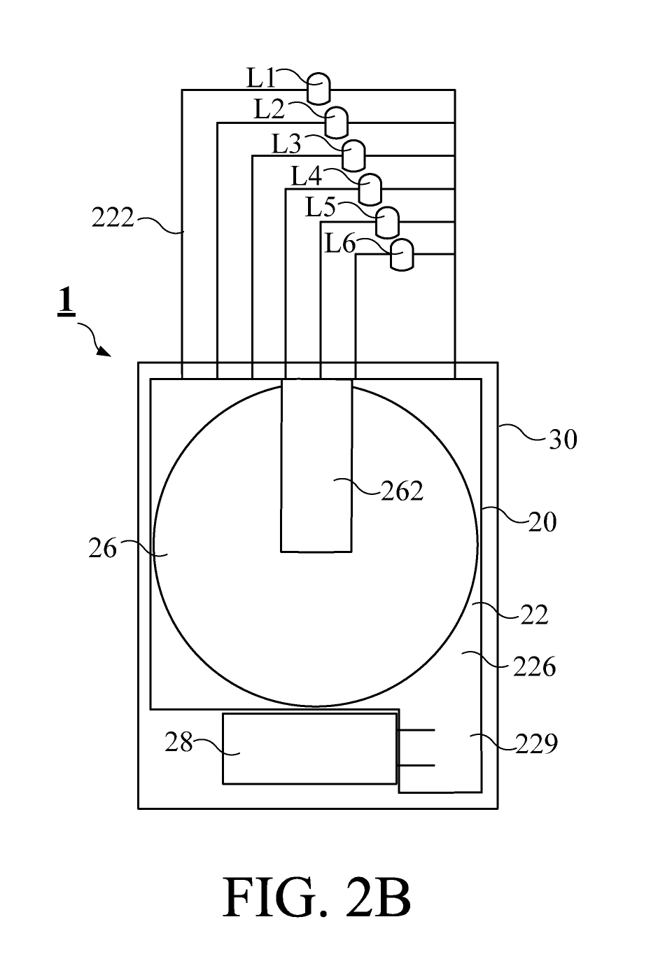

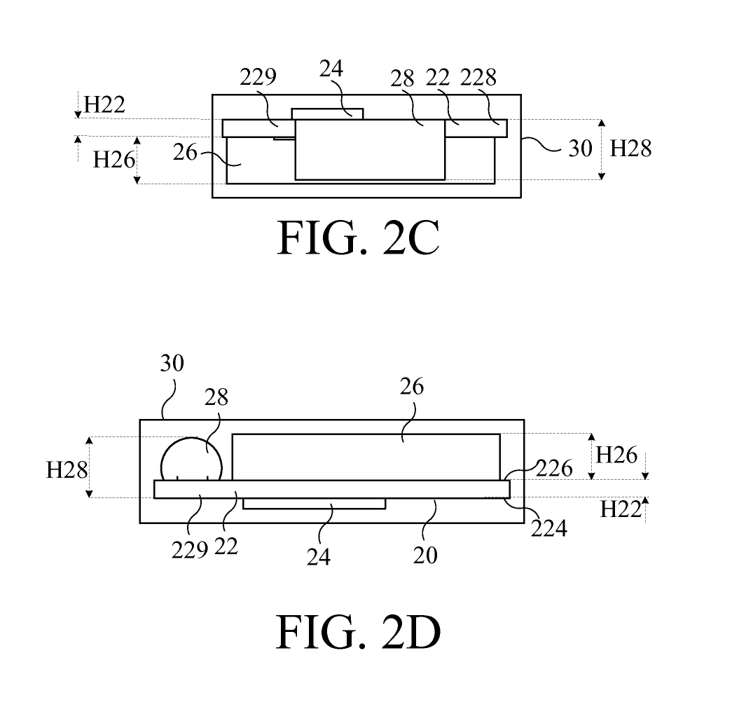

The present invention provides a light-emitting module. Please refer to FIG. 1, FIG. 2A, and FIG. 2B, FIG. 1 is a schematic perspective view illustrating the light-emitting module of the present invention according to a preferred embodiment. FIG. 2A is a schematic top view illustrating the light-emitting module of the present invention according to a preferred embodiment. FIG. 2B is a schematic bottom view illustrating the light-emitting module of the present invention according to a preferred embodiment. A light-emitting module 1 is able to be embedded in an object and emit light.

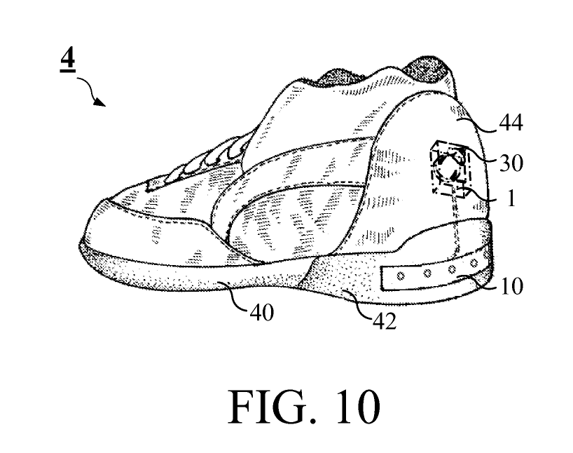

In practical applications, the light-emitting module 1 is able to be embedded in object, the object is able to be a shoe, a clothes, a bag, a backpack, a hat or other objects which can be embedded in. As shown in FIG. 10, FIG. 10 is a schematic diagram illustrating the light-emitting module of the present invention embedded in a shoe 4. A light-emitting component group 10 is set in a heel position 42 of a shoe bottom 40, and a waterproof enclosure 30, and its internal various components are set in a back position 44 of the shoe 4. When the user wears the shoe 4 to walk or run, a control module senses an external force to drive the light-emitting component group 10 to emit light. Moreover, when the user wears the shoe 4 to walk or run at night, the light-emitting component group 10 is able to provide a safe lighting.

In the present embodiment, the light-emitting module 1 comprises a light-emitting component group 10, a control module 20, a waterproof enclosure 30.

The composition of the control module 20 will be described below. In the present embodiment, the control module 20 comprises a circuit board 22, a control chip 24, a power supply module 26, and a vibration sensing component 28. The control chip 24 may refer to a single chip; the power supply module 26 may refer to a top surface and a bottom surface respectively to indicate a positive electrode and a negative electrode of thin-type battery; and the circuit board 22 may refer to a double-sided circuit board.

More specifically, the circuit board 22 in the present embodiment has a first surface 224, a corresponding second surface 226, a side surface 228, and a tongue portion 229. The tongue portion 229 is extended outwards from the side surface 228 of the circuit board 22. Then, the first surface 224 is coupled and mounted with a control chip 24. At the same time, the second surface 226 of the circuit board 22 is set with a power supply module 26. The power supply module 26 is coupled and mounted to the second surface 226 of the circuit board 22 by an electrode 262.

On the other hand, in the present embodiment, the vibration sensing component 28 is penetrated out from first surface 224 by an electrode after the vibration sensing component 28 is entered and penetrated into second surface 226 by the electrode, for being coupled to the circuit of the first surface 224. Thereby the vibration sensing component 28 is also mounted to the side surface 228 of the circuit board 22, and the end surface of the vibration sensing component 28 is corresponding to the side surface of tongue portion 229.

As described above, the light-emitting component group 10 comprises a plurality of light-emitting components. In the present embodiment, light-emitting components L1˜L6 are able to be light-emitting diodes with various wavelength of visible light, such as red, blue, green, yellow, or other colors etc. Light-emitting components L1˜L6 is separately coupled to circuit board 22 by a conducting wire. In the present embodiment, light-emitting component group 10 has six light-emitting components, but is not limited thereto, in practical applications, the quantity of light-emitting components, as the case to appropriately adjust the quantity. For easily identification, symbols L1˜L6 are set for the plurality of light-emitting components according to their locations from one end to the other end. In practical applications, the light-emitting component group 10 is coupled and controlled by the control chip 24 of the circuit board 22 to obtain electrical power from the power supply module 26 to flash according to predetermined mode.

Then, the waterproof enclosure 30 of the present invention is used for sealing the circuit board 22, the control chip 24, the power supply module 26, the vibration sensing component 28, and one end of each conducting wire 222 is connected with the circuit board 22 of the light-emitting component group 10. The water-proof enclosure 19 ensures that the control module 20 of the light-emitting module 1 is unable to be damped, oxidized and dirtied, and extends the service lifetime of the light-emitting module 1. In the present embodiment, the waterproof enclosure 30 is a one piece formed transparent enclosure. In practical applications, the material of the waterproof enclosure 30 is able to be resin, plastic, or transparent enclosure formed by plastic material, but is not limited to the transparent material, which is able to be replaced by another materials having colors.

Moreover, please further refer to FIG. 1, FIG. 2C, and FIG. 2D, FIG. 2C is a schematic diagram of side surface illustrating the light-emitting module of the present invention according to a preferred embodiment, FIG. 2D is a schematic diagram of the other side surface illustrating the light-emitting module of the present invention according to a preferred embodiment. Please look at the schematic diagram of the assembly completed state, the thickness H28 of the vibration sensing component 28 is larger than the thickness H22 of the circuit board 22, and the sum of the thicknesses H26, H22 of the power supply module 26 and the circuit board 22 is larger than the thickness H28 of the vibration sensing component 28.

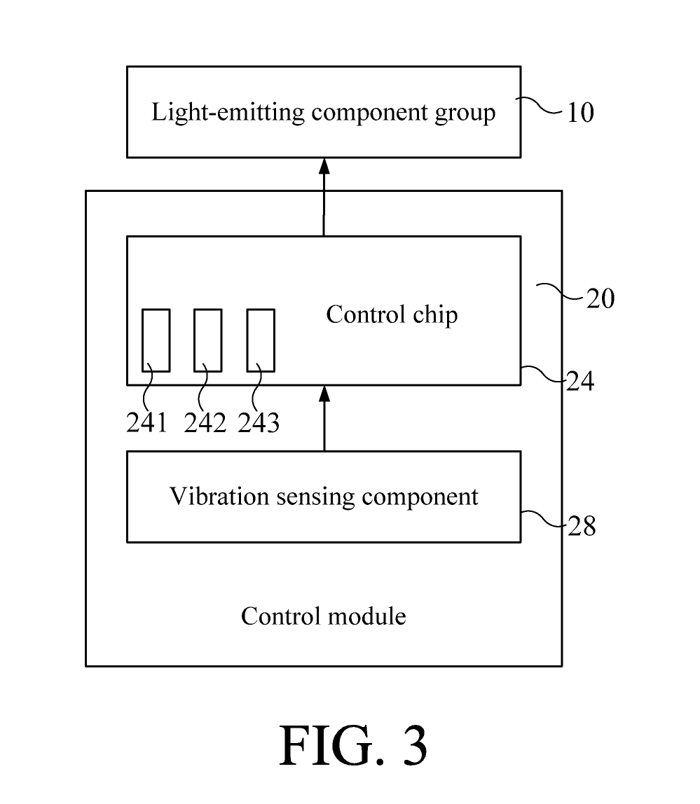

Moreover, please refer to FIG. 3. FIG. 3 is a simplified functional block diagram illustrating the light-emitting module of the present invention according to a preferred embodiment. As shown in FIG. 3, the light-emitting module 1 comprises the light-emitting component group 10 and the control module 20. Light-emitting components L1˜L6 of the light-emitting component group 10 are coupled to the control module 20, wherein the control module 20 further comprises a first flashing circuit 241, a second flashing circuit 242, and a third flashing circuit 243.

Wherein, the first flashing circuit 241, the second flashing circuit 242, and the third flashing circuit 243 are arranged by a predetermined order. After the vibration sensing component 28 of the control module 20 senses an external force to generate a corresponding control signal, the control chip 24 of the control module 20 receives the control signal and sequentially switches between the first flashing circuit 241, the second flashing circuit 242, and the third flashing circuit 243 to control the light-emitting component group 10 for a corresponding flashing, wherein the first flashing circuit 241, the second flashing circuit 242, and the third flashing circuit 243 are formed in the control chip 24.

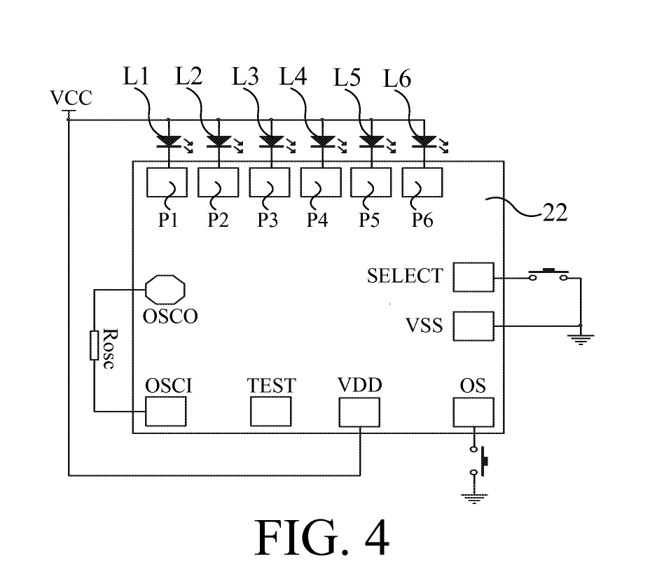

Then, please refer to FIG. 4 is a schematic circuit diagram illustrating the light-emitting module of the present invention according to a preferred embodiment. The symbols P1˜P6 at the circuit board 22 of the light-emitting module 1 of the present invention stand for the contacts P1˜P6 of the plurality of light-emitting components L1˜L6 respectively, symbol VSS stands for the negative of power, symbol OS stands for the vibration sensing component, symbol TEST stands for the test end of the internal circuit, symbol VDD stands for the positive of power, symbol OSCI stands for the oscillation input, symbol OSCO stands for the oscillation output, symbol R_{OSC} stands for the external oscillation resistor, symbol SELECT stands for selective switch.

Wherein, the external oscillation resistor ROSC is coupled to the oscillation input OSCI and the oscillation output OSCO for speeding up the flashing frequency built-in the light-emitting module 1. When the vibration sensing component OS senses action of the object to generate control signal, the control module sequentially switches between the first flashing circuit, the second flashing circuit, and the third flashing circuit to control light-emitting components L1˜L6 for a corresponding flashing.

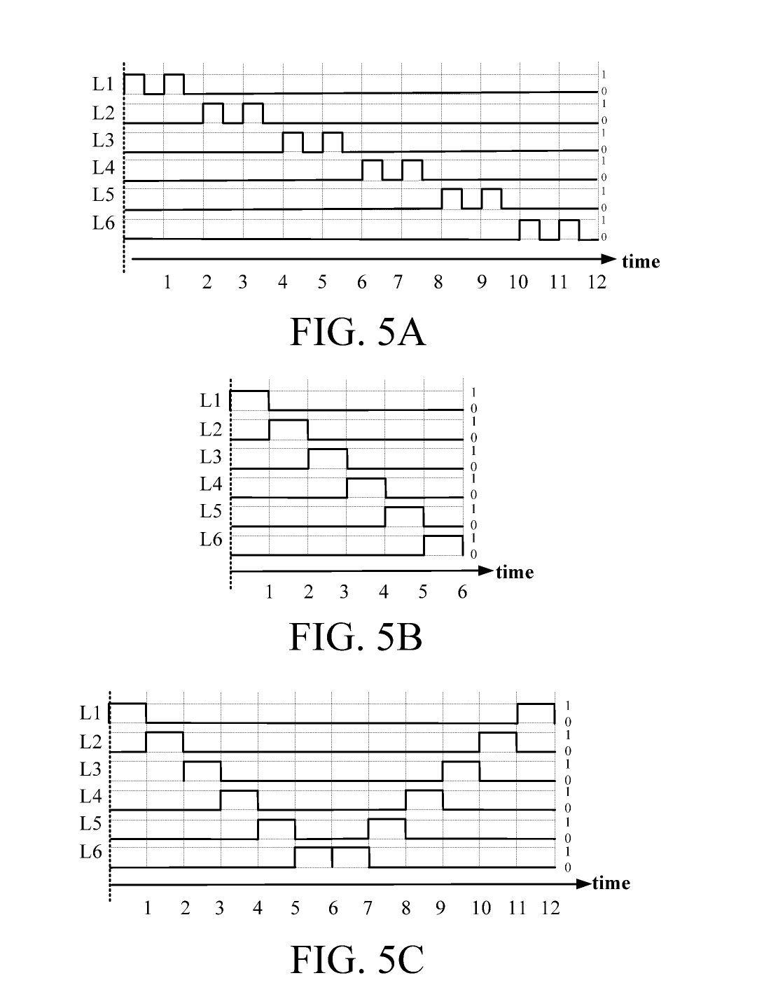

Then, firstly please refer to FIG. 5A, FIG. 5B, and FIG. 5C. FIG. 5A to FIG. 5C are waveform diagrams of first flashing circuit, second flashing circuit, and third flashing circuit respectively illustrating the light-emitting component group in the light-emitting module of the present invention according to a preferred embodiment. Wherein, in the preferred embodiment, the first flashing circuit, the second flashing circuit, and the third flashing circuit are corresponding to a shaking flashing circuit, a sequential flashing circuit, and a round flashing circuit respectively. In the present embodiment, symbols in the time axis stand for the quantity of the time interval. In practical applications, each time intervals is 0.1 second, namely while the time interval marked “10” means that the time duration is about one second, but the length of time interval is not limited thereto, inventors are able to freely set the length of time interval according to their need, such as 0.05 second or 0.2 second etc., the present invention would not pay more restrictions on their length of time interval. Additionally, in the present embodiment, the symbol “0” in the longitudinal axis stands for light-emitting components L1˜L6 in non-lighting (or unpowered) state, and the symbol “1” in the longitudinal axis stands for light-emitting components L1˜L6 in lighting (or powered) state. It should be noted that, the symbol “0” and the symbol “1” are only used for standing for each component in the “OFF” and “ON” state, but whether the brightness is the same, that is not the question in the present invention.

More particularly, after the vibration sensing component 28 senses an external force to generate a corresponding first control signal, the control module 20 starts the shaking flashing circuit according to the first control signal. The shaking flashing circuit comprises at least one shaking procedure, and the shaking procedure is that the light-emitting component group respectively flashes a plurality of times according to a predetermined direction, as shown in FIG. 5A. In the present embodiment, the shaking procedure means that each light-emitting components L1˜L6 individually and sequentially flash twice light off in each two time interval.

Then, after the vibration sensing component 28 senses an external force to generate a corresponding second control signal, the control module 20 starts the sequential flashing circuit according to the second control signal. The sequential flashing circuit comprises at least one sequential procedure, and the sequential procedure is that the light-emitting component group respectively flashes one time according to the predetermined direction. And in the present embodiment, as shown in the FIG. 5B, the sequential procedure means that each light-emitting components L1˜L6 individually and sequentially light for a time length about one interval.

Then, after the vibration sensing component 28 senses an external force to generate a corresponding third control signal, the control module 20 starts the round flashing circuit according to the third control signal. The round flashing circuit comprises at least one round procedure, and the round procedure is that the light-emitting component group respectively flashes one time according to the predetermined direction, and respectively and reversely flashes one time according to the predetermined direction. As shown in the FIG. 5C, the round procedure means that each light-emitting components L1˜L6 individually and sequentially emit light for a time length about one interval, and then respectively and reversely emit light for a time length about one interval. But not limited thereto, in practical applications, the shaking flashing circuit comprises a plurality of shaking flashing procedures, the sequential flashing circuit comprises a plurality of sequential flashing procedures, and the round flashing circuit comprises a plurality of round flashing procedures.

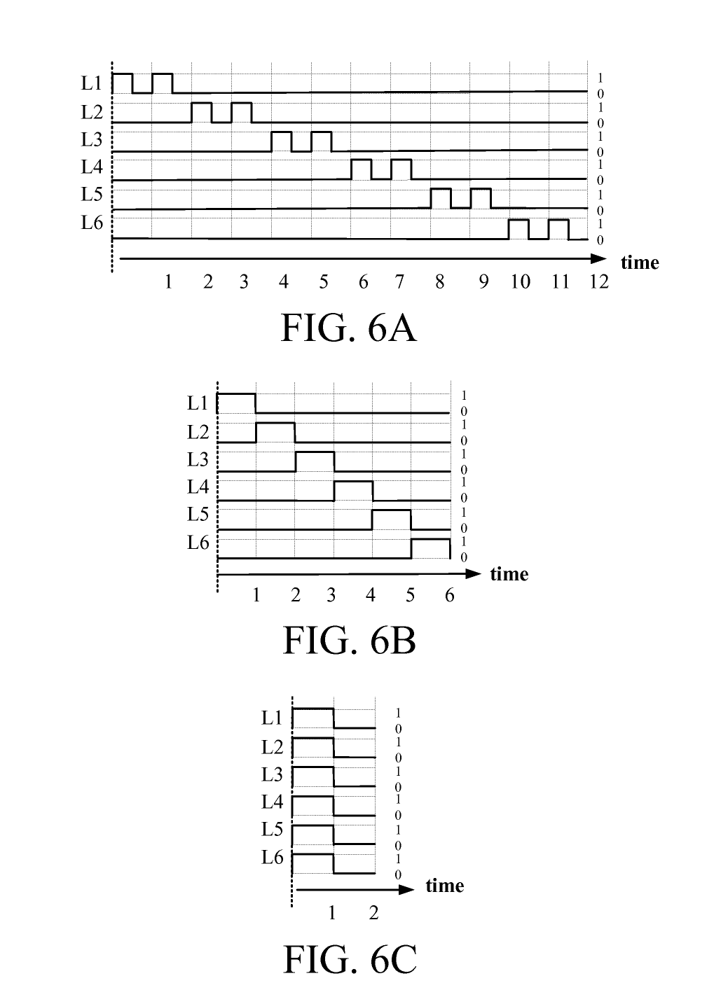

Then, please refer to FIG. 6A, FIG. 6B, and FIG. 6C. FIG. 6A to FIG. 6C are waveform diagrams of first flashing circuit, second flashing circuit, and third flashing circuit respectively illustrating the light-emitting component group in the light-emitting module of the present invention according to another preferred embodiment. Wherein, in the specific embodiment, the first flashing circuit, the second flashing circuit, and the third flashing circuit are corresponding to a shaking flashing circuit, a sequential flashing circuit, and a full flashing circuit respectively.

Firstly, after the vibration sensing component senses an external force to generate a corresponding first control signal, the control module starts the shaking flashing circuit according to the first control signal. The shaking flashing circuit comprises at least one shaking procedure, and the shaking procedure is that the light-emitting component group respectively flashes a plurality of times according to a predetermined direction. And, in the present embodiment, as shown in FIG. 6A, the shaking procedure means that each light-emitting components L1˜L6 individually and sequentially flash twice light off in each two time interval, but is not limited thereto.

Then, after the vibration sensing component senses an external force to generate a corresponding second control signal, the control module starts the sequential flashing circuit according to the second control signal. The sequential flashing circuit comprises at least one sequential procedure, and the sequential procedure is that the light-emitting component group respectively flashes one time according to the predetermined direction. And in the present embodiment, as shown in the FIG. 6B, the sequential procedure means that each light-emitting components L1˜L6 individually and sequentially light for a time length about one interval, but is not limited thereto.

Then, after the vibration sensing component senses an external force to generate a corresponding third control signal, the control module starts the full flashing circuit according to the third control signal. The full flashing mode comprises at least one full procedure, and the full procedure is that the light-emitting component group flashes simultaneously. And in the present embodiment, as shown in the FIG. 6C, the full procedure means that each light-emitting components L1˜L6 simultaneously flash one light off in each two time interval, but is not limited thereto. In practical applications, the shaking flashing circuit comprises a plurality of shaking flashing procedures, the sequential flashing circuit comprises a plurality of sequential flashing procedures, and the full flashing circuit comprises a plurality of full flashing procedures.

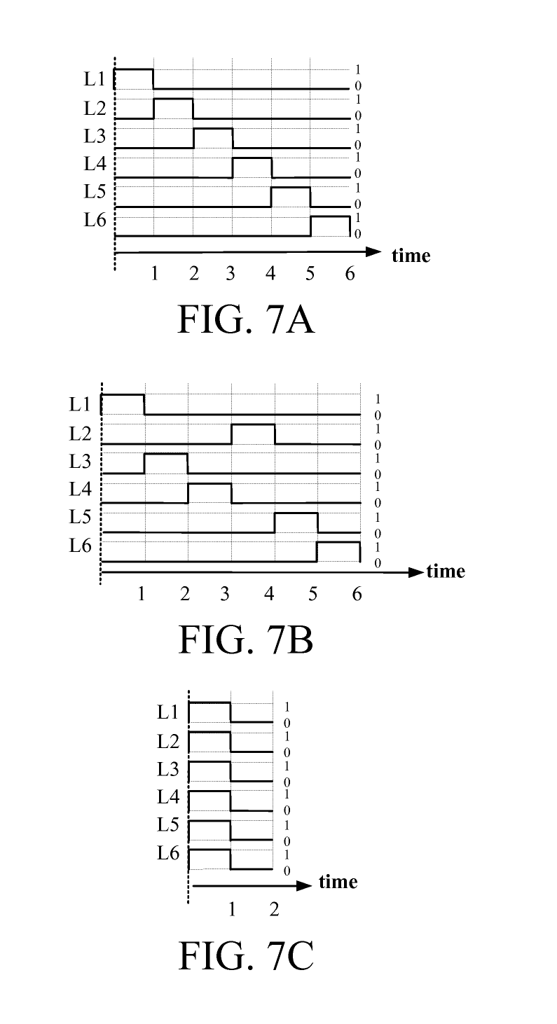

Firstly please refer to FIG. 7A, FIG. 7B, and FIG. 7C. FIG. 7A to FIG. 7C are waveform diagrams of first flashing circuit, second flashing circuit, and third flashing circuit respectively illustrating the light-emitting component group in the light-emitting module of the present invention according to another preferred embodiment. Wherein, in the preferred embodiment, the first flashing circuit, the second flashing circuit, and the third flashing circuit are corresponding to a sequential flashing circuit, a scrolling flashing circuit, and a full flashing circuit respectively.

Firstly, after the vibration sensing component senses an external force to generate a corresponding first control signal, the control module starts the sequential flashing circuit according to the first control signal. The sequential flashing circuit comprises at least one sequential procedure, and the sequential procedure is that the light-emitting component group respectively flashes one time according to the predetermined direction. And in the present embodiment, as shown in the FIG. 7A, the sequential procedure means that each light-emitting components L1˜L6 individually and sequentially light for a time length about one interval, but is not limited thereto.

Then, after the vibration sensing component senses an external force to generate a corresponding second control signal, the control module starts the scrolling flashing circuit according to the second control signal. The scrolling flashing mode comprises at least one scrolling procedure. The scrolling procedure is that the light-emitting component group flashes in a round non-unidirectional way according to the predetermined direction. And in the present embodiment, as shown in the FIG. 7B, the scrolling procedure means that each light-emitting components L1, L3˜L4 individually and sequentially emit light for a time length about one interval, and then return from the L2, L5˜L6 individually and sequentially to emit light for a time length about one interval, but is not limited thereto.

Then, after the vibration sensing component senses an external force to generate a corresponding third control signal, the control module starts the full flashing circuit according to the third control signal. The full flashing mode comprises at least one full procedure, and the full procedure is that the light-emitting component group flashes simultaneously. And in the present embodiment, as shown in the FIG. 6C, the full procedure means that each light-emitting components L1˜L6 simultaneously flash one light off in each two time interval, but is not limited thereto. In practical applications, the sequential flashing circuit comprises a plurality of sequential flashing procedures, the scrolling flashing circuit comprises a plurality of scrolling flashing procedures, and the full flashing circuit comprises a plurality of full flashing procedures.

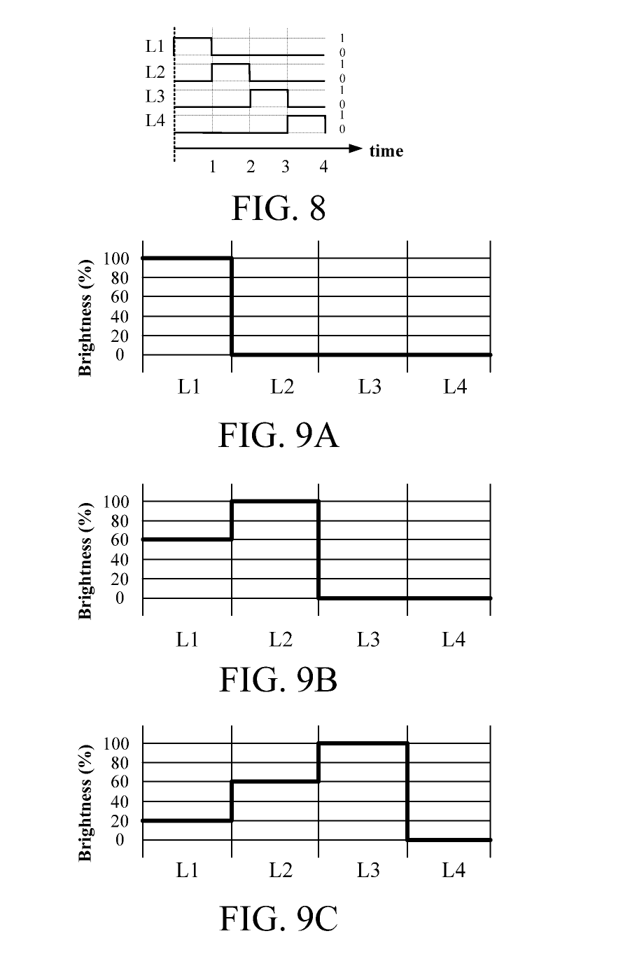

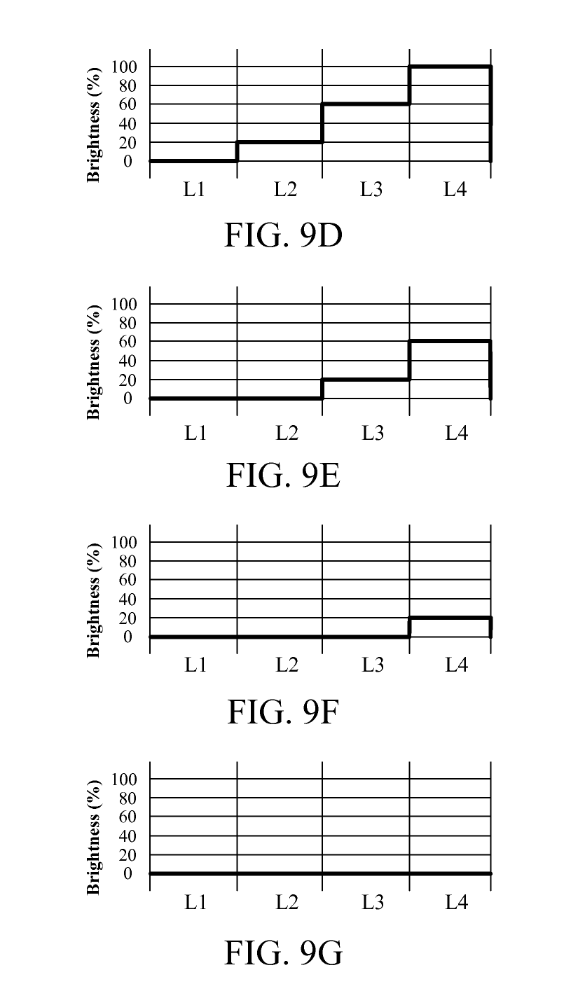

Firstly, please refer to FIG. 8 and FIG. 9A to FIG. 9C. FIG. 8 is a waveform diagram of first flashing circuit illustrating the light-emitting component group in the light-emitting module of the present invention according to another preferred embodiment. FIG. 9A to FIG. 9G are diagrams of second flashing circuit illustrating the light-emitting component group in the light-emitting module of the present invention according to another preferred embodiment. Wherein, in the preferred embodiment, the first flashing circuit and the second flashing circuit are corresponding to a sequential flashing circuit and a meteor flashing circuit respectively.

Firstly, after the vibration sensing component senses an external force to generate a corresponding first control signal, the control module starts the sequential flashing circuit according to the first control signal. The sequential flashing circuit comprises at least one sequential procedure, and the sequential procedure is that the light-emitting component group respectively flashes one time according to the predetermined direction. And in the present embodiment, as shown in the FIG. 8, the sequential procedure means that each light-emitting components L1˜L4 individually and sequentially light for a time length about one interval, but is not limited thereto. In practical applications, the light-emitting component group may also be a plurality of light-emitting components, such as light-emitting components L1˜L6.

Then, after the vibration sensing component senses an external force to generate a corresponding second control signal, the control module starts the meteor flashing circuit according to the second control signal. The meteor flashing mode comprises at least one meteor procedure, the meteor procedure is that the light-emitting component group respectively flashes and sequentially adjusts the brightness of the light-emitting component group according to the predetermined direction. And in the present embodiment, as shown in the FIG. 9A to 9G, the meteor procedure means that the each light-emitting components L1˜L4 individually and sequentially flash and sequentially adjust the brightness of the light-emitting components L1˜L4, but is not limited thereto. In practical applications, the light-emitting component group may also be a plurality of light-emitting components, such as light-emitting components L1˜L6. The light-emitting component L1 emits light first with 100% brightness, as shown in FIG. 9A, then the light-emitting component L1 diminishes with 60% brightness and the light-emitting component L2 emits light with 100% brightness, as shown in FIG. 9B, then the light-emitting component L1 and L2 diminish with 20% and 60% brightness and the light-emitting component L3 emits light with 100% brightness, as shown in FIG. 9C, then the light-emitting component L1 goes out and the light-emitting component L2 and L3 diminish with 20% and 60% brightness and the light-emitting component L4 emits light with 100% brightness, as shown in FIG. 9D, then the light-emitting component L2 goes out and the light-emitting component L3 and L4 diminish with 20% and 60% brightness, as shown in FIG. 9E, then the light-emitting component L3 goes out and the light-emitting component L4 diminishes with 20% brightness, as shown in FIG. 9F, then the light-emitting component L4 goes out, as shown in FIG. 9G.

Additionally, in sequence from FIG. 9A to FIG. 9G, the time interval between each figures is one time interval. In practical applications, each time intervals is 0.1 second, namely meaning that the time duration is about 0.6 second from FIG. 9A to FIG. 9G. But the length of time interval is not limited thereto, inventors are able to freely set the length of time interval according to their need, such as 0.05 second or 0.2 second etc., the present invention would not pay more restrictions on their length. In practical applications, the sequential flashing circuit comprises a plurality of sequential flashing procedures and the meteor flashing circuit comprises a plurality of meteor flashing procedures.

Additionally, in another preferred embodiment, the flashing circuit is similar to the flashing mode, as shown in the FIG. 1 to FIG. 4. In the present embodiment, the light-emitting module of the present invention comprises a light-emitting component group and a control module. The control module is coupled to the light-emitting component group. N flashing modes stored in the control module is arranged to form a flashing cycle according to a predetermined sequence, wherein when an external force is applied to the control module, the control module is switched to the next flashing mode according to the predetermined sequence and controls the light-emitting component group to emit light according to the next flashing mode; and when an (N+1)^{th} external force is applied to the control module, the control module is switched to a first flashing mode of the flashing cycle and controls the light-emitting component group to emit light according to the first flashing mode.

In another preferred embodiment, the flashing circuit is similar to the flashing mode, as shown in the FIG. 5A, FIG. 5B, and FIG. 5C. N flashing modes comprise a first flashing mode, a second flashing mode, and a third flashing mode corresponding to a shaking flashing mode, a sequential flashing mode, and a round flashing mode respectively. The shaking flashing mode comprises at least one shaking procedure. The shaking procedure is that the light-emitting component group respectively flashes a plurality of times according to a predetermined direction. The sequential flashing mode comprises at least one sequential procedure. The sequential procedure is that the light-emitting component group respectively flashes one time according to the predetermined direction. The round flashing mode comprises at least one round procedure. The round procedure is that the light-emitting component group respectively flashes one time according to the predetermined direction, and respectively and reversely flashes one time according to the predetermined direction. In practical applications, the shaking flashing mode comprises a plurality of shaking flashing procedures, the sequential flashing mode comprises a plurality of sequential flashing procedures, and the round flashing mode comprises a plurality of round flashing procedures.

In another preferred embodiment, the flashing circuit is similar to the flashing mode, as shown in the FIG. 6A, FIG. 6B, and FIG. 6C. N flashing modes comprise the first flashing mode, a second flashing mode, and a third flashing mode corresponding to a shaking flashing mode, a sequential flashing mode, and a full flashing mode respectively. The shaking flashing mode comprises at least one shaking procedure. The shaking procedure is that the light-emitting component group respectively flashes a plurality of times according to a predetermined direction. The sequential flashing mode comprises at least one sequential procedure. The sequential procedure is that the light-emitting component group respectively flashes one time according to the predetermined direction. The full flashing mode comprises at least one full procedure. The full procedure is that the light-emitting component group flashes simultaneously. In practical applications, the shaking flashing mode comprises a plurality of shaking flashing procedures, the sequential flashing mode comprises a plurality of sequential flashing procedures, and the full flashing mode comprises a plurality of full flashing procedures.

In another preferred embodiment, the flashing circuit is similar to the flashing mode, as shown in the FIG. 7A, FIG. 7B, and FIG. 7C. N flashing modes comprise the first flashing mode, a second flashing mode, and a third flashing mode corresponding to a sequential flashing mode, a scrolling flashing mode, and a full flashing mode respectively. The sequential flashing mode comprises at least one sequential procedure. The sequential procedure is that the light-emitting component group respectively flashes one time according to the predetermined direction. The scrolling flashing mode comprises at least one scrolling procedure. The scrolling procedure is that the light-emitting component group flashes in a round non-unidirectional way according to the predetermined direction. The full flashing mode comprises at least one full procedure. The full procedure is that the light-emitting component group flashes simultaneously. In practical applications, the sequential flashing mode comprises a plurality of sequential flashing procedures, the scrolling flashing mode comprises a plurality of scrolling flashing procedures, and the full flashing mode comprises a plurality of full flashing procedures.

In another preferred embodiment, the flashing circuit is similar to the flashing mode, as shown in the FIG. 8 and FIG. 9A to FIG. 9G. N flashing modes comprise the first flashing mode and a second flashing mode corresponding to a sequential flashing mode and a meteor flashing mode respectively. The sequential flashing mode comprises at least one sequential procedure. The sequential procedure is that the light-emitting component group respectively flashes one time according to the predetermined direction. The meteor flashing mode comprises at least one meteor procedure. The meteor procedure is that the light-emitting component group respectively flashes and sequentially adjusts the brightness of the light-emitting component group according to the predetermined direction. In practical applications, the sequential flashing mode comprises a plurality of sequential flashing procedures and the meteor flashing mode comprises a plurality of meteor flashing procedures.

Additionally, the present invention further provides a light-emitting module. The flashing circuit is similar to the flashing mode, as shown in the FIG. 1 to FIG. 4. In the present embodiment, the present invention comprises a light-emitting component group and a control module. The control module is coupled to the light-emitting component group. N flashing modes stored in the control module for controlling the light-emitting component group to light. The N flashing modes arranged from a first flashing mode to an N^{th} flashing mode to form a flashing cycle, and N is an integer number larger than 3. Wherein, when an X^{th} external force is applied to the control module, the control module is switched from an (x−1)^{th} flashing mode to an X^{th} flashing mode, and x is smaller than or equal to N.

In a preferred embodiment, when the X^{th} external force is applied and the (x−1)^{th} flashing mode is not finished yet, the control module terminates the (x−1)^{th} flashing mode and directly controls the light-emitting component group to flash according to the X^{th} flashing mode.

In another preferred embodiment, when the X^{th} external force is applied and the (x−1)^{th} flashing mode is not finished yet, the control module controls the light-emitting component group to flash sequentially according to the X^{th} flashing mode after the light-emitting component group is finished to flash according to the (x−1)^{th} flashing mode.

In another preferred embodiment, when the X^{th} external force is applied and the (x−1)^{th} flashing mode is not finished yet, the control module is switched to the X^{th} flashing mode after the light-emitting component group is finished to flash according to the (x−1)^{th} flashing mode, and when an (x+1)^{th} external force is applied, the control module controls the light-emitting component group to flash according to the X^{th} flashing mode.

Additionally, the present invention further provides a light-emitting module. In the present embodiment, the flashing circuit is similar to the flashing mode, as shown in the FIG. 1 to FIG. 4. In the present embodiment, the present invention provides a light-emitting module comprising a light-emitting component group, a control module, and a selective switch. The control module is coupled to the light-emitting component group. N flashing modes is stored in the control module for controlling the light-emitting component group to emit light. The selective switch is coupled to the control module. In the present embodiment, the present invention is able to set a button on the transparent enclosure for controlling the selective switch to start or not (not shown in the figure), but the start of the selective switch is not limited to the invention for setting the button on transparent enclosure.

Wherein when the selective switch is triggered by a user, the control module selects x flashing modes from the N flashing modes, and the x flashing modes arranged from a first flashing mode to an X^{th} flashing mode to form a flashing cycle, N and x are a positive integer number respectively, and x is smaller than N.

Wherein when an y^{th} external force is applied to the control module, the control module is switched from an (y−1)′^{h} flashing mode to an y^{th} flashing mode for controlling the light-emitting component group to emit light, and y is smaller than or equal to x; and when an (x+1)^{th} external force is applied to the control module, the control module controls the light-emitting component group to emit light according the first flashing mode.

Compared to the prior arts, the present invention provides a light-emitting module. The light-emitting module is able to utilize a control module for sensing an external force to control a plurality of light-emitting components sequentially switched for flashing between the first flashing mode, the second flashing mode and the third flashing mode according to a flashing cycle, which enhances the light-emitting module to flash in various ways. At the same time, the control module of the light-emitting module of the present invention is simple. Therefore the light-emitting module is able to provide the light emitting or the lighting function with saving space to solve the disadvantages of the prior arts.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A light-emitting module, comprising:
a light-emitting component group; and
a control module coupled to the light-emitting component group and having N flashing modes stored therein, the N flashing modes arranged to form a flashing cycle according to a predetermined sequence;
wherein when an external force is applied to the control module, the control module is switched to the next flashing mode according to the predetermined sequence and controls the light-emitting component group to emit light according to the next flashing mode; and when an (N+1)th external force is applied to the control module, the control module is switched to a first flashing mode of the flashing cycle and controls the light-emitting component group to emit light according to the first flashing mode.

2. The light-emitting module of claim 1, wherein the N flashing modes comprise the first flashing mode, a second flashing mode, and a third flashing mode corresponding to a shaking flashing mode, a sequential flashing mode, and a round flashing mode respectively, the shaking flashing mode comprises at least one shaking procedure, the shaking procedure is that the light-emitting component group respectively flashes a plurality of times according to a predetermined direction, the sequential flashing mode comprises at least one sequential procedure, the sequential procedure is that the light-emitting component group respectively flashes one time according to the predetermined direction, the round flashing mode comprises at least one round procedure, the round procedure is that the light-emitting component group respectively flashes one time according to the predetermined direction, and respectively and reversely flashes one time according to the predetermined direction.

3. The light-emitting module of claim 1, wherein the N flashing modes comprise the first flashing mode, a second flashing mode, and a third flashing mode corresponding to a shaking flashing mode, a sequential flashing mode, and a full flashing mode respectively, the shaking flashing mode comprises at least one shaking procedure, the shaking procedure is that the light-emitting component group respectively flashes a plurality of times according to a predetermined direction, the sequential flashing mode comprises at least one sequential procedure, the sequential procedure is that the light-emitting component group respectively flashes one time according to the predetermined direction, the full flashing mode comprises at least one full procedure, and the full procedure is that the light-emitting component group flashes simultaneously.

4. The light-emitting module of claim 1, wherein the N flashing modes comprise the first flashing mode, a second flashing mode, and a third flashing mode corresponding to a sequential flashing mode, a scrolling flashing mode, and a full flashing mode respectively, the sequential flashing mode comprises at least one sequential procedure, the sequential procedure is that the light-emitting component group respectively flashes one time according to the predetermined direction, the scrolling flashing mode comprises at least one scrolling procedure, the scrolling procedure is that the light-emitting component group flashes in a round non-unidirectional way according to the predetermined direction, the full flashing mode comprises at least one full procedure, and the full procedure is that the light-emitting component group flashes simultaneously.

5. The light-emitting module of claim 1, wherein the N flashing modes comprise the first flashing mode and a second flashing mode corresponding to a sequential flashing mode and a meteor flashing mode respectively, the sequential flashing mode comprises at least one sequential procedure, the sequential procedure is that the light-emitting component group respectively flashes one time according to the predetermined direction, the meteor flashing mode comprises at least one meteor procedure, the meteor procedure is that the light-emitting component group respectively flashes and sequentially adjusts the brightness of the light-emitting component group according to the predetermined direction.

6. The light-emitting module of claim 1, wherein the control module comprises:
a circuit board, having a first surface, a corresponding second surface, and a side surface;
a control chip, coupled and mounted to the first surface of the circuit board, for being coupled to and controlling the light-emitting component group;
a power supply module, coupled and mounted to the second surface of the circuit board; and
a vibration sensing component, coupled to the second surface of the circuit board and mounted to the side surface of the circuit board.

7. The light-emitting module of claim 6, wherein the circuit board has a tongue portion, the tongue portion is extended outwards from the side surface of the circuit board for being coupled to the vibration sensing component.

8. The light-emitting module of claim 6, wherein the thickness of the vibration sensing component is larger than the thickness of the circuit board, the sum of the thicknesses of the power supply module and the circuit board is larger than the thickness of the vibration sensing component.

9. A shoe with a light-emitting module, comprising:
a shoe body embedding the light-emitting module; and
the light-emitting module comprising:
a light-emitting component group; and
a control module, coupled to the light-emitting component group, having N flashing modes stored therein, the N flashing modes arranged from a first flashing mode to an N^{th} flashing mode to form a flashing cycle, and N is an integer number larger than 3;
wherein when an x^{th} external force is applied to the control module, the control module is switched from an (x−1)′^{h} flashing mode to an x^{th} flashing mode, and x is smaller than or equal to N.

10. The shoe of claim 9, wherein when the x^{th} external force is applied and the (x−1)^{th} flashing mode is not finished yet, the control module terminates the (x−1)^{th} flashing mode and directly controls the light-emitting component group to flash according to the x^{th} flashing mode.

11. The shoe of claim 9, wherein when the x^{th} external force is applied and the (x−1)^{th} flashing mode is not finished yet, the control module controls the light-emitting component group to flash sequentially according to the x^{th} flashing mode after the light-emitting component group is finished to flash according to the (x−1)^{th} flashing mode.

12. The shoe of claim 9, wherein when the x^{th} external force is applied and the (x−1)^{th} flashing mode is not finished yet, the control module is switched to the x^{th} flashing mode after the light-emitting component group is finished to flash according to the (x−1)^{th} flashing mode, and when an (x+1)^{th} external force is applied, the control module controls the light-emitting component group to flash according to the x^{th} flashing mode.

13. A light-emitting module, comprising:
a light-emitting component group;
a control module, coupled to the light-emitting component group, N flashing modes stored in the control module for controlling the light-emitting component group to emit light; and
a selective switch, coupled to the control module;
wherein when the selective switch is triggered by a user, the control module selects x flashing modes from the N flashing modes, and the x flashing modes arranged from a first flashing mode to an x^{th} flashing mode to form a flashing cycle, N and x are a positive integer number respectively, and x is smaller than or equal to N;
wherein when an y^{th} external force is applied to the control module, the control module is switched from an (y−1)^{th} flashing mode to an y^{th} flashing mode for controlling the light-emitting component group to emit light, and y is smaller than or equal to x; and when an (x+1)^{th} external force is applied to the control module, the control module controls the light-emitting component group to emit light according the first flashing mode.
